(19) United States
(12) Patent Application Publication
(10) Pub. No.: US 2012/0222218 A1
(43) Pub. Date: Sep. 6, 2012

(54) PILLOW CASE WITH MULTIPLE ENCLOSURES

(75) Inventors: Edmund Scott Davis, Oakland Park, FL (US); Keith Richard Coponi, Pkland Park, FL (US)

(73) Assignee: BANYAN LICENSING, LLC, Fort Lauderdale, FL (US)

(21) Appl. No.: 13/411,051

(22) Filed: Mar. 2, 2012

Related U.S. Application Data
(60) Provisional application No. 61/449,460, filed on Mar. 4, 2011.

(51) Int. Cl. A47G 9/02; B23P 11/00

(52) U.S. Cl. 5/490; 29/428

(57) ABSTRACT

Embodiments of the invention are directed to a pillow case with multiple enclosures. In some embodiments, a pillow case comprises a first enclosure that comprises a first edge and a second edge, and a second enclosure that comprises a first edge and a second edge. The first edge of the first enclosure is hinged to the first edge of the second enclosure via a first hinged connection. Additionally, both the first and second enclosures receive pillow-filling material.

### CROSS-REFERENCE TO RELATED APPLICATIONS

This patent application claims priority to and hereby incorporates by reference the entire contents of U.S. Provisional Patent Application No. 61/449,460 entitled “Pillow Case With Multiple Enclosures” filed on Mar. 4, 2011.

### FIELD OF THE INVENTION

The present invention relates to pillow cases and pillows.

### BACKGROUND OF THE INVENTION

A pillow is generally useful for the purpose of rendering comfort or support to various parts of a person's body. In some instances, a pillow may even be used for decorative purposes. A pillow case is a shell or cover that is used to protect a pillow from direct contact with a person's body or from direct contact with the general environment. A pillow case may also be referred to as a pillow slip or a sham. A pillow case may be manufactured with natural fibers, synthetic fibers, or blends of natural and synthetic fibers. A pillow case usually has a single enclosure that receives a single pillow. Therefore, for any purpose that requires multiple pillows to be arranged in a specific configuration, multiple independent pillows (and a pillow case for each pillow) need to be used.

For instance, if a person wants to sleep on a flat bed with his or her head in an elevated resting position, where a single pillow is not capable of producing the desired elevation, he or she would need to stack two or more pillows on top of each other. However, the problem with such a configuration is that the top pillow may frequently slip out of position due to constant movement of a person's head. Alternatively, that person may buy a pillow that has a greater thickness than usual pillows. However, pillows are usually of standard thickness, and thus, it may be difficult to find a pillow that produces elevation greater than that provided by a single standard pillow. As a further instance of a purpose that requires multiple pillows to be arranged in a specific configuration, multiple independent pillows may be configured in a particular arrangement on a sofa for decorative purposes. However, the original configuration in which the pillows were arranged may constantly be disturbed as people get up from, or sit down on, a sofa.

Therefore, there is a need for an assembly that allows a user to effectively utilize multiple pillows as a unitary member, but with the flexibility to adjust the pillows into multiple configurations. The assembly may then be used for purposes that require multiple pillows to be arranged in specific configurations.

### SUMMARY OF THE INVENTION

Embodiments of the invention are directed to a pillow case with multiple enclosures. In some embodiments, an exemplary assembly comprises a first enclosure, the first enclosure having a first edge with length L and a second edge with width W, wherein L is greater than W; a second enclosure, the second enclosure having a first edge with length L2 and a second edge with width W2, wherein L2 is greater than W2; wherein the first enclosure is hinged with the second enclosure via a hinged connection along at least a portion of the first edge of the first enclosure and at least a portion of the first edge of the second enclosure; and wherein the first enclosure receives pillow-filling material; and wherein the second enclosure receives pillow-filling material.

In some embodiments, the hinged connection comprises a connection between a point along the first edge of the first enclosure and a point along the first edge of the second enclosure.

In some embodiments, the first enclosure can rotate about the hinged connection independently of the second enclosure.

In some embodiments, the second enclosure can rotate about the hinged connection independently of the first enclosure.

In some embodiments, L is substantially equal to L2.

In some embodiments, L is greater than L2.

In some embodiments, at least one of the first and second enclosures is partitioned.

In some embodiments, an exemplary assembly comprises a first enclosure that comprises at least one edge; a second enclosure that comprises at least one edge; a third enclosure that comprises at least one edge; and a single hinged connection that connects a first edge of the first enclosure, a first edge of the second enclosure, and a first edge of the third enclosure, wherein the first enclosure receives pillow-filling material, the second enclosure receives pillow-filling material, and the third enclosure receives pillow-filling material.

In some embodiments, the first enclosure is to rotate about the hinged connection independently of the second enclosure and the third enclosure, the second enclosure is to rotate about the hinged connection independently of the first enclosure and the third enclosure, and the third enclosure is to rotate about the hinged connection independently of the first enclosure and the second enclosure.

In some embodiments, at least one of the first, second, and third enclosures is partitioned.

In some embodiments, an exemplary assembly comprises a first enclosure that comprises a first edge and a second edge; a second enclosure that comprises a first edge and a second edge; a third enclosure that comprises a first edge and a second edge; wherein the first edge of the first enclosure is hinged to the first edge of the second enclosure via a first hinged connection; wherein the first edge of the third enclosure is hinged to the second edge of the second enclosure via a second hinged connection; and wherein the first enclosure receives pillow-filling material, the second enclosure receives pillow-filling material, and the third enclosure receives pillow-filling material.

In some embodiments, the first hinged connection allows the first enclosure to rotate about the first hinged connection independently of the second enclosure, and wherein the second hinged connection allows the third enclosure to rotate about the second hinged connection independently of the second enclosure.

In some embodiments, an exemplary method for connecting a first enclosure with a second enclosure, comprises: providing a first enclosure, the first enclosure having a first edge with length L and a second edge with width W, wherein L is greater than W; receiving pillow-filling material into the first enclosure; providing a second enclosure, the second enclosure having a first edge with length L2 and a second edge with width W2, wherein L2 is greater than W2; receiving pillow-filling material into the second enclosure; and connecting the first enclosure to the second enclosure via a hinged connection along at least a portion of the first edge of the first enclosure and at least a portion of the first edge of the second enclosure such that the first enclosure can rotate about the hinged connection independently of the second enclosure.

In some embodiments, the method further comprises partitioning at least one of the first and second enclosures.

In some embodiments, an exemplary method for connecting a first enclosure, a second enclosure, and a third enclosure, comprises: providing a first enclosure; receiving pillow-filling material into the first enclosure; providing a second enclosure; receiving pillow-filling material into the second enclosure; providing a third enclosure; receiving pillow-filling material into the third enclosure; and connecting the first enclosure, the second enclosure, and the third enclosure via a single hinged connection along at least a portion of the first edge of the first enclosure and at least a portion of the first edge of the second enclosure to hingedly connect with each other via a single hinged connection such that each enclosure can rotate about the hinged connection independently of the other enclosures.

In some embodiments, at least one of the first, second, and third enclosures is partitioned.

In some embodiments, an exemplary method for connecting a first enclosure, a second enclosure, and a third enclosure, comprises: providing a first enclosure; receiving pillow-filling material into the first enclosure; providing a second enclosure; receiving pillow-filling material into the second enclosure; providing a third enclosure; receiving pillow-filling material into the third enclosure; connecting the first enclosure to the second enclosure via a first hinged connection such that the first enclosure can rotate about the first hinged connection independently of the second enclosure; and connecting the third enclosure to the second enclosure via a second hinged connection such that the third enclosure can rotate about the second hinged connection independently of the second enclosure.

In some embodiments, at least one of the first, second, and third enclosures is partitioned.

### BRIEF DESCRIPTION OF THE DRAWINGS

Reference will now be made to the accompanying drawings, which are not necessarily drawn to scale, and wherein:

FIG. 1 is a perspective view illustrating an assembly with two enclosures, according to one embodiment of the invention;

FIG. 2 is a plan view illustrating the assembly of FIG. 1;

FIG. 3 is a perspective view illustrating an assembly with four (4) enclosures, according to another embodiment of the invention;

FIG. 4 is a perspective view illustrating an assembly with three (3) enclosures, according to another embodiment of the invention;

FIG. 5 is a perspective view illustrating an assembly with three (3) enclosures, according to another embodiment of the invention;

FIG. 6 is a perspective view illustrating an assembly with three (3) enclosures, according to another embodiment of the invention;

FIG. 7 is a perspective view illustrating an assembly with three (3) enclosures, according to another embodiment of the invention;

FIG. 8 is a perspective view illustrating an assembly with three (3) enclosures, according to another embodiment of the invention;

FIG. 9 is a perspective view illustrating an assembly with three (3) enclosures, according to another embodiment of the invention;

FIG. 10 is a perspective view illustrating an assembly with three (3) enclosures, according to another embodiment of the invention;

FIG. 11 is a perspective view illustrating an assembly with three (3) enclosures, according to another embodiment of the invention;

FIG. 12 is a perspective view illustrating an assembly with three (3) enclosures, according to another embodiment of the invention; and

FIG. 13 is a perspective view illustrating an assembly with three (3) enclosures, according to another embodiment of the invention.

### DETAILED DESCRIPTION OF THE INVENTION

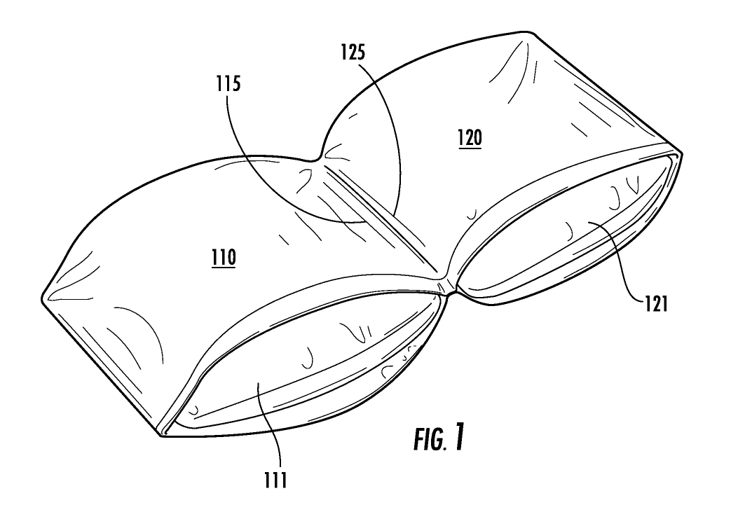

Referring to FIG. 1, there is illustrated a perspective view of an assembly 100 with two (2) enclosures 110 and 120, wherein each enclosure may hold one or more corresponding pillows 111 and 121. As used herein with respect to various embodiments of the invention, an “enclosure” may comprise an opening to receive a pillow or, in some embodiments, an enclosure may be a pillow in itself. In some embodiments, each enclosure may be hollow and may be able to receive more than one (1) pillow. In other embodiments, rather than receiving a pillow, each enclosure receives material such as wool, feather, polyester, fiber, foam, other synthetic material, fluid inside a bladder, or the like. The invention is not limited to any type of material that can be received into an enclosure, provided the material provides the desired level of support, resiliency and comfort to the user when positioned on or against the assembly. Moreover, each enclosure may be filled with a different type of material. That way, each enclosure may be used for a different purpose. For instance, a first enclosure may be filled with material that provides stiffer support and resiliency, while another enclosure may be filled with material that provides less support and resiliency so as to provide greater comfort, while still another enclosure may be filled with material that provides memory properties. For each figure described below, the enclosure comprises a pillow or some other material, each of these being generally referred to herein as a “pillow” or “pillow-filling material”.

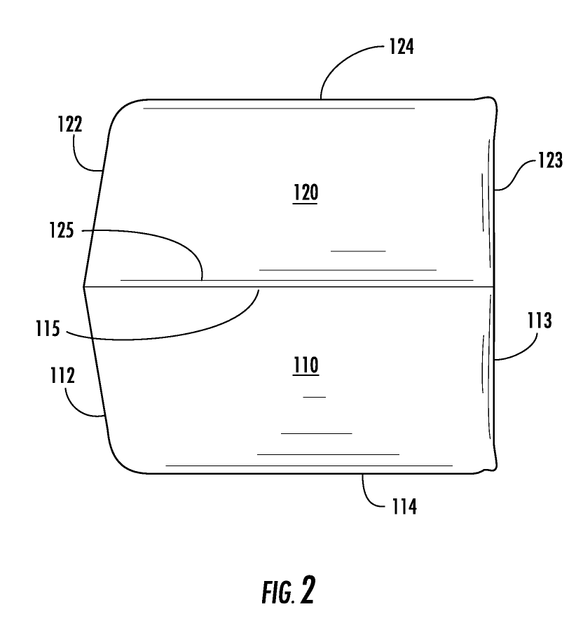

In one embodiment, each enclosure is generally rectangular as shown in FIGS. 1 and 2. However, in other embodiments, each enclosure may take any shape. Moreover, while one enclosure of the pillow case or assembly may take one shape (e.g., rectangular), another enclosure of the same pillow case or assembly may take a different shape (e.g., cylindrical). In some embodiments, as shown in FIGS. 1 and 2, each enclosure of the assembly has not only a similar shape, but also similar dimensions. However, in other embodiments, each enclosure of the assembly may not only have different shapes, but may also have different dimensions. Consequently, enclosures may be able to receive pillows of different sizes and different dimensions.

In another embodiment, an enclosure may be partitioned. In one embodiment, the enclosure is partitioned by attaching one or more partitions or dividers (e.g., a piece of fabric or other material (such as the material used to construct the enclosure)) within the enclosure along at least a portion of the length L of the enclosure so that one or more pillows may be inserted into each partitioned portion.

In one embodiment, as shown in FIG. 1, an edge 115 of enclosure 110 is hinged with an edge 125 of an enclosure 120. A pillow 111 is received into enclosure 110 and a pillow 121 is received into enclosure 120. In one embodiment, the edges 115 and 125 of each enclosure along which the two (2) enclosures are hinged are of substantially similar length. However, in other embodiments, the edge of one enclosure may be shorter or longer than the edge of the other enclosure to which the edge of the first enclosure is hinged. While, in one embodiment, the two (2) enclosures are hinged along the entire length of each enclosure's edge 115, 125 (as presented in FIG. 2), in another embodiment, the two (2) enclosures are hinged along a partial length of each enclosure's edge. In still another embodiment, the two (2) enclosures are hinged at a point along an edge of each enclosure. In still another embodiment, the two (2) enclosures are hinged at one or more discontinguous points along an edge of each enclosure. In still another embodiment, the two (2) enclosures are hinged at one or more corners of each enclosure. In still another embodiment, a point anywhere on the body of one enclosure is hinged with a point anywhere on the body of the second enclosure. In still another embodiment, a surface of one enclosure is hinged, either partially or entirely, with the surface of the second enclosure. While the discussion above describes two (2) enclosures being hinged, the same features may apply to one enclosure being hinged to two or more other enclosures.

Regardless of how the two (2) enclosures in FIGS. 1 and 2 are hinged with each other, the two (2) enclosures can fold away separately from each other, i.e., the first enclosure can move about the hinge or hinged connection independently of the second enclosure. In some embodiments, the two (2) enclosures can also rotate about the hinge or hinged connection independently of each other.

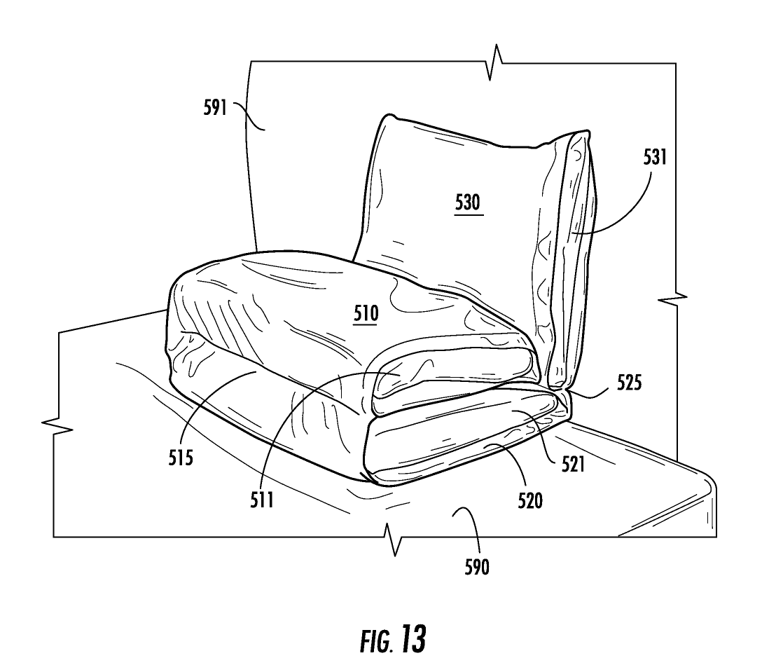

As used herein, the term “hinged” refers to a first enclosure being movably connected to one or more other enclosures and may include either an undetachable or detachable connection. As used herein, “detachable” means that the connection is structured to be connected and disconnected by the user (e.g., using a mechanical fastener, such as a zipper or a loop and hook fastener, snaps, etc.). An example of a hinged connection 515 is visible in FIG. 13. In embodiments where an edge of a first enclosure 510 is hinged to an edge of a second enclosure 520, the hinged connection may be a thin cylinder or barrel that has a length substantially similar to the length of an edge of an enclosure. For those enclosures that are hinged to this hinged connection 515, in some embodiments, the hinged connection 515 may permit easy folding and/or rotation of those enclosures about the hinged connection's axis. In some embodiments, the hinged connection 515 may only permit a limited angle of rotation. In some embodiments, the thin cylinder that functions as a hinged connection 515 may be manufactured with flexible and/or soft material, while in other embodiments, the thin cylinder may be manufactured with more rigid material. In other embodiments, the hinged connection 515 may comprise a mechanical device in place of, or in addition to, the thin cylinder. In another embodiment, a hinged connection can comprise one enclosure having one or more seams sown at least partially along the length L of the enclosure.

In some embodiments, a piece of cloth may function as the hinged connection 515 between a first enclosure 510 and a second enclosure 520. This may be possible when both enclosures are stitched onto the same piece of base cloth. The piece of cloth that functions as the connection between the first enclosure 510 and the second enclosure 520 should be wide enough and flexible enough in order to allow a first enclosure 510 to be able to rotate about the hinged connection independently of the second enclosure 520, at least to some degree of rotation. In some embodiments, the piece of cloth that functions as the hinged connection needs to be wide enough in order to allow the first enclosure 510 to be stacked on top of the second enclosure 520.

In some embodiments, as described above, a first enclosure may even be detachably hinged to one or more other enclosures. The manner by which a first enclosure is connected/attached/hinged to one or more other enclosures or disconnected/detached/unhinged from one or more other enclosures is not limited to the manner, methods, or mechanisms described herein.

As described in various embodiments below, the invention is not limited to an assembly with two (2) enclosures.

Referring to FIG. 2, there is illustrated a plan view of the assembly with two (2) enclosures 110 and 120 illustrated in FIG. 1. Enclosure 110 is defined by edges 112, 113, 114, and 115. Enclosure 120 is defined by edges 122, 123, 124, and 125. As presented in FIG. 2, in one embodiment, the two (2) enclosures are hinged along an entire length of an edge 115, 125 of each enclosure. As presented in FIG. 2, in one embodiment, the two (2) enclosures are hinged along a longer edge 115, 125 of each enclosure. However, in other embodiments, the two (2) enclosures could be hinged along a shorter edge 112, 122 of each enclosure. Also, as described above, in some embodiments, a longer edge 115 of one enclosure could be hinged to a shorter edge 122 of a second enclosure.

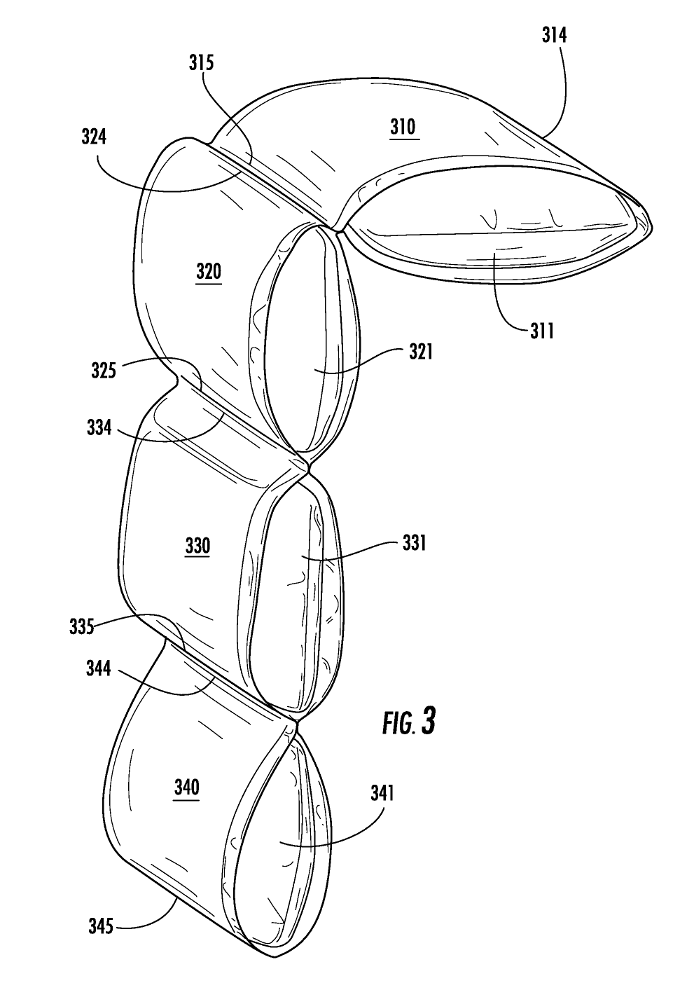

Referring now to FIG. 3, there is illustrated a perspective view of an assembly 300 with four (4) enclosures 310, 320, 330, and 340, which receive pillows 311, 321, 331, and 341 respectively. In this embodiment, an edge 315 of the first enclosure 310 is hinged to an edge 324 of the second enclosure 320. Furthermore, an edge 325 of the second enclosure 320 is hinged to an edge 334 of the third enclosure 330. In other embodiments, the second enclosure 320 may be hinged to third enclosure 330 along the second enclosure's edge 324, rather than the second enclosure's edge 325. Furthermore, an edge 335 of the third enclosure 330 is hinged to an edge 344 of the fourth enclosure 340. In other embodiments, the third enclosure 330 may be hinged to the fourth enclosure 340 along either of the second enclosure's edges 324, 325. In another embodiment, there may be more enclosures than the number of enclosures displayed in FIG. 3, and each additional enclosure could be hinged to an enclosure that is already on the chain. Assuming there are no hinges along edges 314 (of enclosure 310) and 345 (of enclosure 340), in this embodiment, the number of hinges may always be one less than the number of enclosures on the chain of enclosures. For instance, in the embodiment presented in FIG. 3, there are four (4) enclosures 310, 320, 330, and 340 and three (3) hinges along edges 315/324, 325/334, and 335/344. In some embodiments, any edge presented in FIG. 3 (314, 315, 324, 325, 334, 335, 344, 345) may be hinged to any other edge.

Although FIG. 3 presents that the first enclosure 310 is hinged to the second enclosure 320 along their respective edges, in other embodiments, the first enclosure 310 may be hinged to the second enclosure 320 via any of the hinged mechanisms described previously with respect to FIG. 2. Similarly, although FIG. 3 presents that the second enclosure 320 is hinged to the third enclosure 330 along their respective edges, in other embodiments, the second enclosure 320 may be hinged to the third enclosure 330 via any of the hinged mechanisms described previously with respect to FIG. 2. Similarly, although FIG. 3 presents that the third enclosure 330 is hinged to the fourth enclosure 340 along their respective edges, in other embodiments, the third enclosure 330 may be hinged to the fourth enclosure 340 via any of the hinged mechanisms described previously with respect to FIG. 2.

Regardless of how each of the enclosures in FIG. 3 is hinged to one or more of the other enclosures, each enclosure can fold away separately from any of the other enclosures at least to a certain predetermined angle, i.e., each enclosure can rotate about the hinged edge independent of other enclosures in the assembly, regardless of whether the enclosure is directly hinged to an enclosure that it is folding away from.

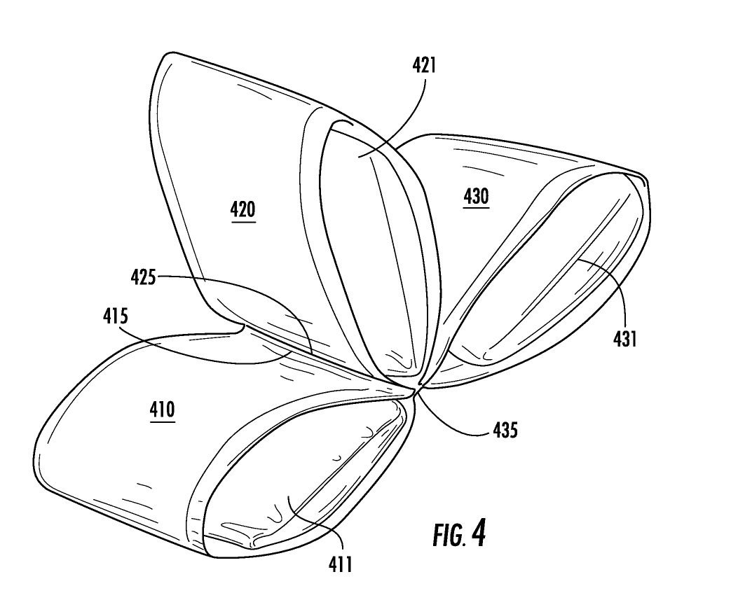

As displayed in FIG. 4, there is illustrated a perspective view of an assembly 400 with three enclosures. In this embodiment, an edge 415 of the first enclosure 410 is hinged to an edge 425 of the second enclosure 420. Although FIG. 4 presents that the first enclosure 410 is hinged to the second enclosure 420 along their respective edges, in other embodiments, the first enclosure 410 may be hinged to the second enclosure 420 via any of the hinged mechanisms described previously with respect to FIG. 2. Furthermore, as presented in FIG. 4, an edge 435 of the third enclosure 430 is hinged with the edges 415 and 425 of the first and second enclosures 410 and 420, respectively.

Regardless of how each of the three (3) enclosures in FIG. 4 is hinged to one or more of the other enclosures, each enclosure can fold separately away from any of the other enclosures or rotate about the hinged edge 415, 425, 435 independently of other enclosures in the assembly at least to a certain predetermined angle, regardless of whether the enclosure is directly hinged to an enclosure that it is folding away from.

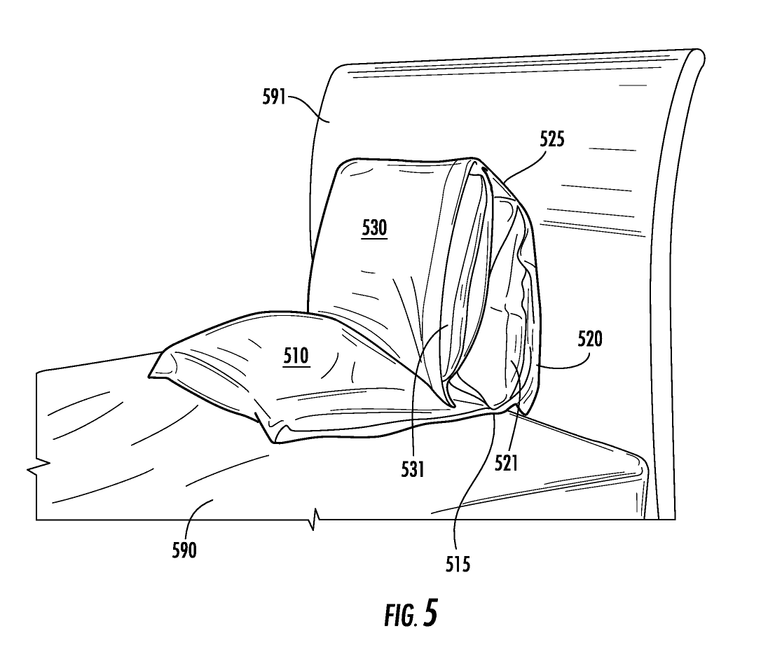

As displayed in FIG. 5, there is illustrated a perspective view of an assembly 500 with three (3) enclosures 510, 520, 530, which receive pillows 511, 521, 531, respectively. Each enclosure is generally rectangular in shape with two (2) longer edges and two (2) shorter edges. In one embodiment, a longer edge of enclosure 510 is hinged with a first longer edge of enclosure 520 via a hinged connection 515, and a longer edge of enclosure 530 is hinged with a second longer edge of enclosure 520 via a hinged connection 525. Regardless of how each of the three (3) enclosures is hinged to one or more of the other enclosures, each enclosure can fold away separately from any of the other enclosures (or rotate about a hinged connection independently of the other enclosures) at least to a certain predetermined angle, regardless of whether the enclosure is directly hinged to an enclosure that is folding away from. As shown in FIG. 5, enclosure 510 can lie flat on a bed while enclosures 520 and 530 are placed in a generally perpendicular position with respect to enclosure 510, and are held in their position by the headboard of the bed. In one embodiment (not shown in FIG. 5), the second longer edge of enclosure 530 may also be hinged to hinged connection 515.

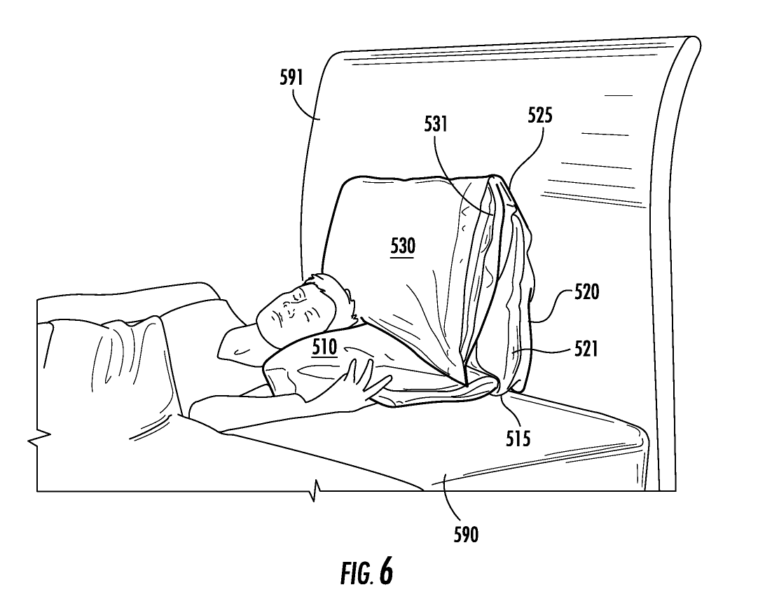

As displayed in FIG. 6, when a pillow is received into the bottom enclosure 510, this enclosure can be used as a pillow on which a person can rest his or her head. Since the other enclosures 520 and 530 (which may also receive pillows 521 and 531, respectively) can fold away separately, they do not interfere with the function of the bottom enclosure 510.

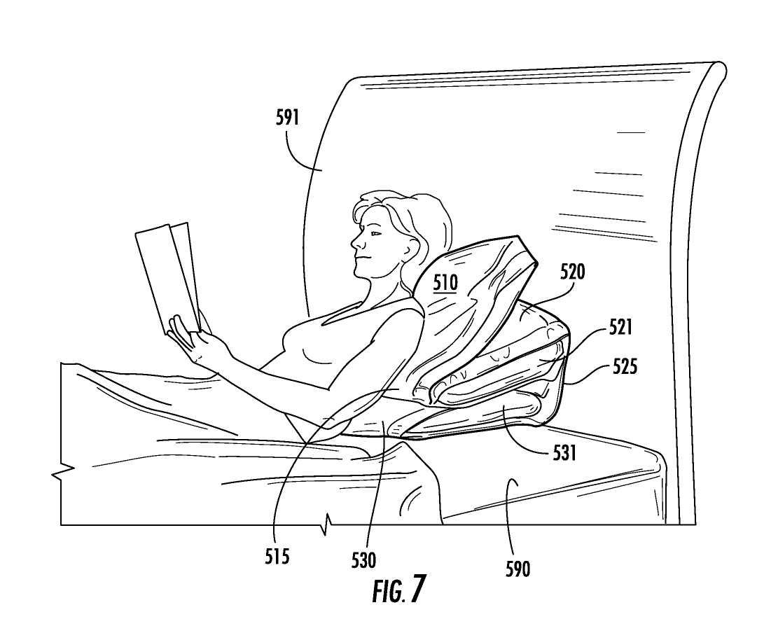

As displayed in FIG. 7, when a pillow is received into each of the three (3) enclosures 510, 520, and 530, each of the three (3) enclosures can be stacked upon each other. The stacked enclosures can be used to simultaneously support the back or neck of a person who wishes to read or watch television, for example, while lying on a bed 590. Moreover, as shown in FIG. 7, the top enclosure 510, which receives a pillow, does not slip away from the other enclosures. This is in contrast to an arrangement where three independent pillows are stacked on top of each other. When three (3) independent pillows are stacked on top of each other, it is very difficult to maintain the arrangement when a person continually moves his or her back and neck against the pillows. Consequently, the person would need to continually rearrange the stack of independent pillows. In some embodiments (not shown in FIG. 7), the second longer edge of enclosure 510, i.e., the edge that is shown as not being hinged in FIG. 7, may also be hinged to hinged connection 525. Similarly, the second longer edge of enclosure 530 may be hinged to hinged connection 515.

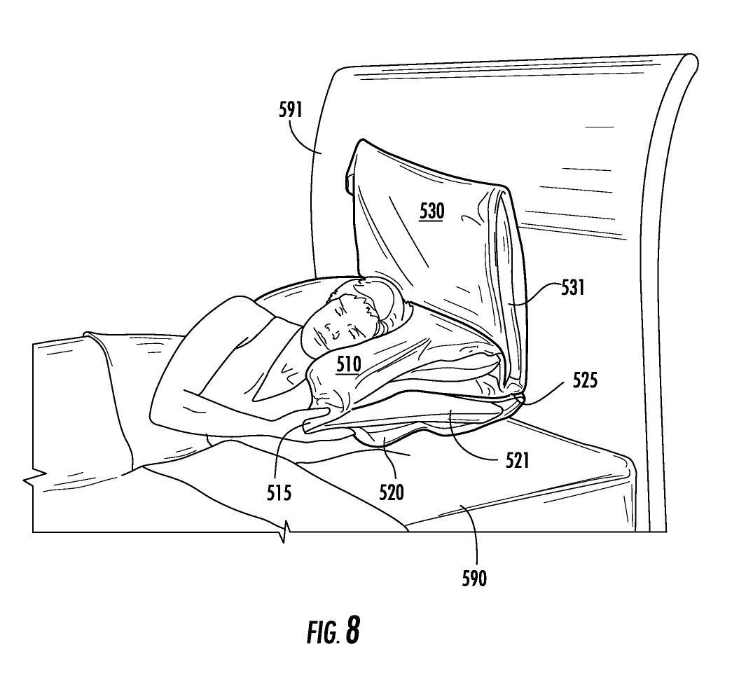

As displayed in FIG. 8, there is illustrated a perspective view of the assembly 500 with three (3) enclosures. In this embodiment, when a pillow is received into enclosures 510 and 520, both these enclosures can be stacked on top of one another to form an elevated pillow assembly. This may be useful for those people who wish to sleep with their heads rested on a slightly elevated pillow assembly in order to be able to sleep more comfortably, or for other purposes such as medical purposes. Since the third enclosure 530 (which also receives a pillow 531) can fold away separately (or rotate about hinged connection 525), it does not interfere with the function of the slightly elevated pillow assembly. In another embodiment, the elevated pillow assembly may comprise enclosures 520 and 530, while enclosure 510 folds away separately (or rotates about hinged connection 515). In still another embodiment, the elevated pillow assembly may comprise enclosures 510 and 530, while enclosure 520 folds away separately.

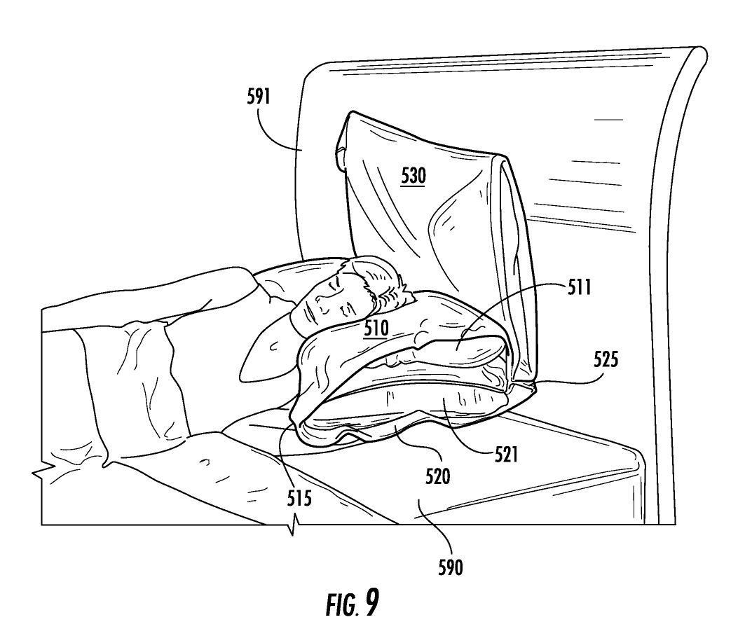

FIG. 9 is similar to FIG. 8. As shown in FIG. 9, the third enclosure 530 which folds away separately can be used to cushion a person's head when the person is resting his or her head on the slightly elevated pillow assembly. The third enclosure 530,which is placed in a generally perpendicular position with respect to the other two enclosures 510 and 520, can also prevent a person's head from hitting the headboard 591 of a bed 590 or a wall if the bed is pushed up against the wall. In some embodiments, the enclosure 510 may have smaller dimensions than enclosures 520 and 530. In such an embodiment, the enclosure 510 may receive a smaller pillow than the pillows receives by enclosures 520 and 530. In such an embodiment, when enclosure 530 receives a pillow, enclosure 530 forms an acute angle with respect to the slightly elevated pillow assembly (stack comprising enclosures 510 and 520) such that enclosure 530 not only cushions the back of a person's head which is resting on the slightly elevated pillow assembly, but also cushions a substantial part of a person's head.

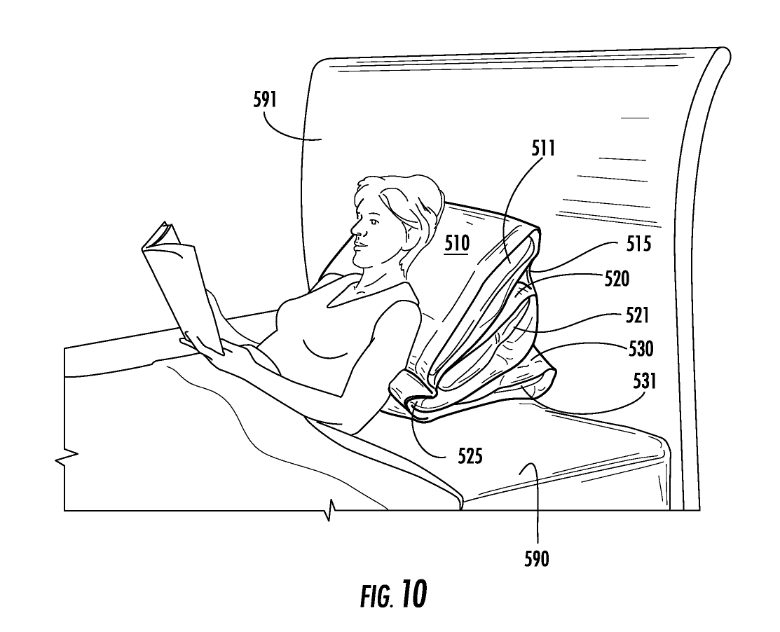

FIG. 10 is similar to FIG. 7. In the embodiment presented in FIG. 10, when a pillow is received into each of the three (3) enclosures 510, 520, and 530, each of the three (3) enclosures can be stacked upon each other. As displayed in FIG. 10, the stacked enclosures can be used to simultaneously support the back, neck, and head of a person who wishes to read or watch television, for example, while lying on a bed.

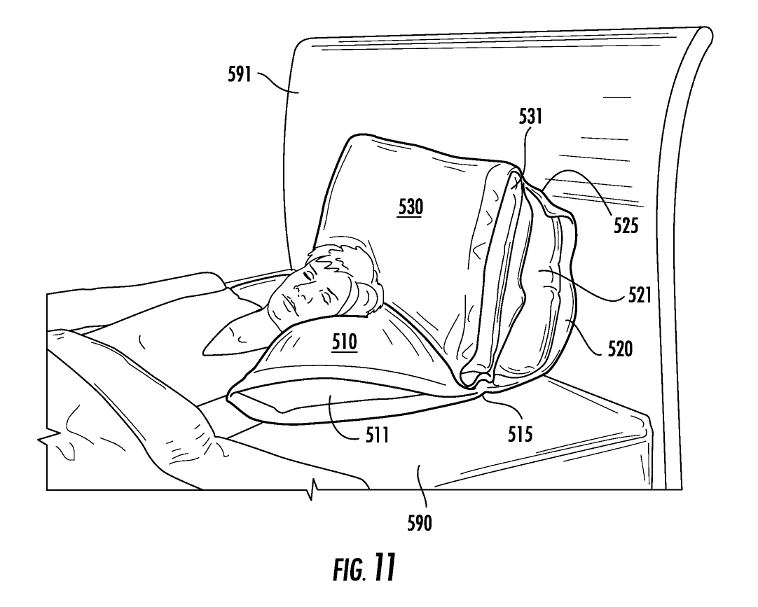

In the embodiment presented in FIG. 11, a pillow 511 received into enclosure 510 is used as a pillow on which a person can rest his or her head. Enclosures 520 and 530, which also receive pillows 521 and 531, respectively, can be stacked in a generally perpendicular configuration (with respect to enclosure 510) as presented in FIG. 11. Since enclosures 520 and 530 fold away separately (enclosure 520 can rotate freely about hinged connection 515 and enclosure 530 can rotate freely about hinged connection 525), they do not interfere with the function of enclosure 510. Moreover, as shown in FIG. 11, the perpendicular enclosures 520 and 530 can be used to cushion a person's head while sleeping. These perpendicular enclosures 520 and 530 can also prevent a person's head from hitting the headboard of a bed or a wall if the bed is pushed up against the wall.

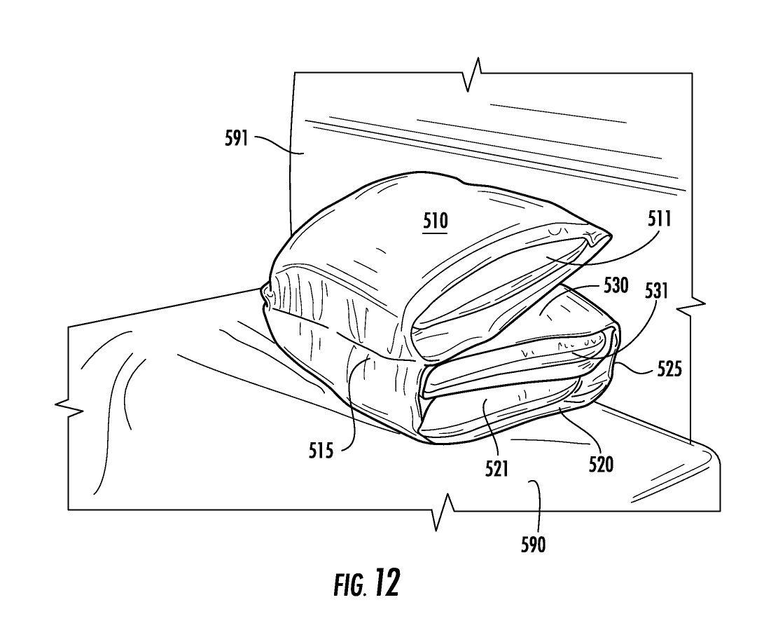

As displayed in FIG. 12, there is illustrated a perspective view of the assembly 500 with three (3) enclosures 510, 520, and 530 which receive pillows 511, 521, and 531, respectively. In the embodiment presented in FIG. 12, enclosure 510 is hinged with enclosure 520 via hinged connection 515 and enclosure 520 is hinged with enclosure 530 via hinged connection 525. The means by which an enclosure can be hinged, or hinged, to another enclosure have been described previously. In the embodiment presented in FIG. 12, the three enclosures are stacked on top of each other. In some embodiments, enclosure 530 may additionally be hinged to hinged connection 515. Moreover, in some embodiments, enclosure 510 may be detachably hinged to hinged connection 525. In some embodiments, a shorter edge of one of the enclosures may also be hinged with the shorter edge of another enclosure. For instance, a shorter edge of enclosure 510 may be hinged to the shorter edge of enclosure 520 or enclosure 530.

As displayed in FIG. 13, there is illustrated a perspective view of the assembly 500 with three (3) enclosures 510, 520, and 530 which receive pillows 511, 521, and 531, respectively. In the embodiment presented in FIG. 13, enclosure 510 is hinged with enclosure 520 via hinged connection 515 and enclosure 520 is hinged with enclosure 530 via hinged connection 525. Enclosures 510 and 520 are stacked on top of each other. Since enclosure 530 can fold away separately from enclosures 510 and 520, i.e., rotate about hinged connection 525 independently of enclosures 510 and 520, enclosure 530 can assume a generally perpendicular position with respect to enclosures 510 and 520.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An assembly, comprising:
a first enclosure, the first enclosure having a first edge with length L and a second edge with width W, wherein L is greater than W;
a second enclosure, the second enclosure having a first edge with length L2 and a second edge with width W2, wherein L2 is greater than W2; wherein the first enclosure is hinged with the second enclosure via a hinged connection along at least a portion of the first edge of the first enclosure and at least a portion of the first edge of the second enclosure;
wherein the first enclosure receives pillow-filling material; and
wherein the second enclosure receives pillow-filling material.

2. The assembly of claim 1, wherein the hinged connection comprises a connection between a point along the first edge of the first enclosure and a point along the first edge of the second enclosure.

3. The assembly of claim 1, wherein the first enclosure can rotate about the hinged connection independently of the second enclosure.

4. The assembly of claim 1, wherein the second enclosure can rotate about the hinged connection independently of the first enclosure.

5. The assembly of claim 1 wherein L is substantially equal to L2.

6. The assembly of claim 1 wherein L is greater than L2.

7. The assembly of claim 1 wherein at least one of the first and second enclosures is partitioned.

8. An assembly, comprising:
a first enclosure that comprises at least one edge;
a second enclosure that comprises at least one edge;
a third enclosure that comprises at least one edge; and
a single hinged connection that connects a first edge of the first enclosure, a first edge of the second enclosure, and a first edge of the third enclosure,
wherein the first enclosure receives pillow-filling material, the second enclosure receives pillow-filling material, and the third enclosure receives pillow-filling material.

9. The assembly of claim 8 wherein, the first enclosure to rotate about the hinged connection independently of the second enclosure and the third enclosure, the second enclosure to rotate about the hinged connection independently of the first enclosure and the third enclosure, and the third enclosure to rotate about the hinged connection independently of the first enclosure and the second enclosure.

10. The assembly of claim 8 wherein at least one of the first, second, and third enclosures is partitioned.

11. An assembly, comprising:
a first enclosure that comprises a first edge and a second edge;
a second enclosure that comprises a first edge and a second edge;
a third enclosure that comprises a first edge and a second edge;
wherein the first edge of the first enclosure is hinged to the first edge of the second enclosure via a first hinged connection;
wherein the first edge of the third enclosure is hinged to the second edge of the second enclosure via a second hinged connection; and
wherein the first enclosure receives pillow-filling material, the second enclosure receives pillow-filling material, and the third enclosure receives pillow-filling material.

12. The assembly of claim 11, wherein the first hinged connection allows the first enclosure to rotate about the first hinged connection independently of the second enclosure, and wherein the second hinged connection allows the third enclosure to rotate about the second hinged connection independently of the second enclosure.

13. A method for connecting a first enclosure with a second enclosure, comprising:
providing a first enclosure, the first enclosure having a first edge with length L and a second edge with width W, wherein L is greater than W;
receiving pillow-filling material into the first enclosure;
providing a second enclosure, the second enclosure having a first edge with length L2 and a second edge with width W2, wherein L2 is greater than W2;
receiving pillow-filling material into the second enclosure; and
connecting the first enclosure to the second enclosure via a hinged connection along at least a portion of the first edge of the first enclosure and at least a portion of the first edge of the second enclosure such that the first enclosure can rotate about the hinged connection independently of the second enclosure.

14. The method of claim 13 further comprising partitioning at least one of the first and second enclosures.

15. A method for connecting a first enclosure, a second enclosure, and a third enclosure, comprising:
providing a first enclosure;
receiving pillow-filling material into the first enclosure;
providing a second enclosure;
receiving pillow-filling material into the second enclosure;
providing a third enclosure;
receiving pillow-filling material into the third enclosure; and
connecting the first enclosure, the second enclosure, and the third enclosure via a single hinged connection along at least a portion of the first edge of the first enclosure and at least a portion of the first edge of the second enclosure to hingedly connect with each other via a single hinged connection such that each enclosure can rotate about the hinged connection independently of the other enclosures.

16. The method of claim 15 wherein at least one of the first, second, and third enclosures is partitioned.

17. A method for connecting a first enclosure, a second enclosure, and a third enclosure, comprising:
providing a first enclosure;
receiving pillow-filling material into the first enclosure;
providing a second enclosure;
receiving pillow-filling material into the second enclosure;
providing a third enclosure;
receiving pillow-filling material into the third enclosure;
connecting the first enclosure to the second enclosure via a first hinged connection such that the first enclosure can rotate about the first hinged connection independently of the second enclosure; and
connecting the third enclosure to the second enclosure via a second hinged connection such that the third enclosure can rotate about the second hinged connection independently of the second enclosure.

18. The method of claim 17 wherein at least one of the first, second, and third enclosures is partitioned.
